(19) United States
(12) Patent Application Publication
(10) Pub. No.: US 2004/0050758 A1
(43) Pub. Date: Mar. 18, 2004

(54) High tensile strength stainless steel screen and method of making thereof

(76) Inventor: Edwin C. Bailey, East Amherst, NY (US)

Correspondence Address: HODGSON RUSS LLP, ONE M & T PLAZA, SUITE 2000, BUFFALO, NY, 14203-2391, US

(21) Appl. No.: 10/642,335

(22) Filed: Aug. 15, 2003

Related U.S. Application Data
(62) Division of application No. 09/766,437, filed on Jan. 19, 2001, now abandoned.
(60) Provisional application No. 60/177,122, filed on Jan. 20, 2000.

(51) Int. Cl. B07B 1/49

(52) U.S. Cl. 209/400; 209/401

(57) ABSTRACT

A non-woven wire mesh screen having a first planar array of stainless steel wires disposed in a longitudinal direction and a second planar array of stainless steel wires disposed transverse to the first planar array. The stainless steel wires have a tensile strength greater than 200,000 psi.

### CROSS-REFERENCE TO RELATED APPLICATION

This application is a divisional based on U.S. patent application Ser. No. 09/766,437 filed Jan. 19, 2001. Applicant claims priority based on Provisional Application No. 60/177,122 filed Jan. 20, 2000, and entitled “High Tensile Strength Stainless Steel Screen and Method of Making Thereof,” which is incorporated herein by reference.

### FIELD OF INVENTION

The present invention relates generally to non-woven wire mesh screens and particularly to a non-woven wire mesh screen constructed of high tensile strength stainless steel.

### BACKGROUND OF THE INVENTION

Screens are used in the aggregate, steel, food and other industrial processes to sort granular products into various sizes. The screens can be made from various types of abrasion resistant material, such as wire, plate, urethane, and rubber.

Wire screens have traditionally been made from medium to high carbon steel. The majority of these screens have been woven where the individual strands of wire are woven like cloth. On larger woven wire screens, the wires have to be pre-crimped in a serpentine manner before weaving so that the joints will interlock to keep the wires from moving.

In steel wires, the abrasive resistance increases as the tensile strength increases. However, wire with high tensile strength is more difficult for a weaver to crimp without cracking.

As an alternative to woven screens there have been screens formed by welding processes. Welded screens are typically also made out of high carbon steel wire as disclosed in U.S. Pat. No. 4,686,342 entitled Process for Making Wire Mesh Screens and U.S. Pat. No. 5,205,877 also entitled Process for Making Wire Mesh Screens, both of which are hereby incorporated by reference.

Also, while most screens are made from medium to high carbon steel, stainless steel has been used in some applications. However, due to the higher costs associated with stainless steel it has not been typically used to sort product unless there was a requirement for stainless such as in the case of food products. Also, welded screens made out of stainless are typically low tensile strength (much less than 200,000 psi) for applications such as fencing, cages, and the like.

In the aggregate and steel industries where large scale sorting occurs, it is a continual goal to extend the life of the screens to reduce the costs of materials, labor and down-time associated with maintaining and replacing the screens. Accordingly, what is needed is a welded mesh screen having a useful life that is greater than the life of conventional medium to high carbon steel screens.

### SUMMARY OF THE INVENTION

The present invention provides a welded screen for sorting granular products that is capable of lasting up to several times longer than comparable screens made out of high carbon/high tensile materials. Applicant has discovered that welded screens constructed from stainless steel having a tensile strength greater than 200,000 psi have significantly longer life than the comparable high carbon steel screens. Although the stainless steel was used because of its inherent resistance to oxidation, it has become apparent that the material also produces a significantly longer life that was not readily apparent or expected.

### BRIEF DESCRIPTION OF THE DRAWINGS

The invention is illustrated in the drawings in which like reference characters designate the same or similar parts throughout the figures of which:

FIG. 1 is a schematic diagram of the process; and,

FIG. 2 is a perspective view of a wire mesh screen according to the present invention.

### DESCRIPTION OF THE PREFERRED EMBODIMENTS

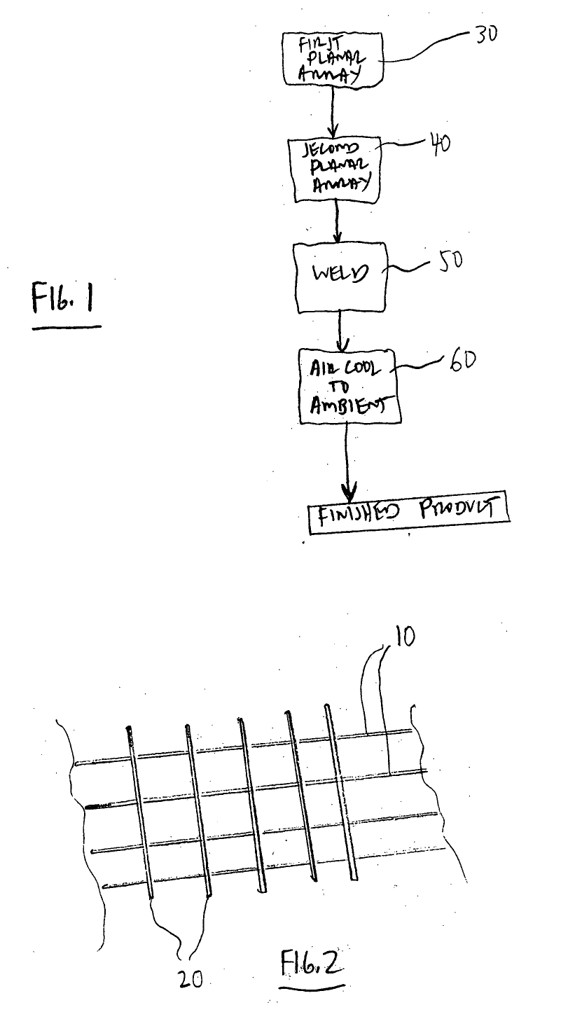

Referring to FIGS. 1 and 2, the process of welding the screens consists of using an AISI type 304 stainless steel or other comparable type of stainless steel that is either in the as drawn or tempered condition so that a tensile strength over 200,000 psi is achieved. The wire size used was 0.375″ (⅜) diameter. Wire diameters ranging from 0.0625″ (1/16) or less and up to 0.625″ (⅝) could also be used.

In FIG. 1, a first array of wires 10 is provided in a longitudinal configuration and a second array of wires 20 is provided in a transverse configuration extending transversely of said first array of wires and forming several wire joints thereby. The terms “longitudinal configuration” and “transverse configuration” are intended to include a first array of wires and a second array of wires that cross in any suitable fashion or at any suitable angle.

In FIG. 2, the strands of wire are laid in an electric resistance welding machine in steps 30 and 40 and a pulse of electricity is applied at their intersections in step 50. This pulse is varied in amplitude and is maintained for less than a second, depending on the wire diameter, until fusion of the wires is achieved. During this process, the wire intersections are squeezed between the weld contacts. As known to those of ordinary skill in the art, the variables of pressure, current and time will vary depending on the wire size and the amount of weld penetration desired. For example only, a ⅜″ diameter set of wires required 2750 pounds of pressure and 5,000 amps for 40 cycles (60 cycles=1 second) at each junction. It has been found that the pressure for the high tensile strength stainless steel is about ten percent higher than that required to weld stainless steel with a tensile strength less than 200,000 psi.

At the end of the weld in step 60, the current and the pressure are removed and the wires are allowed to air cool to ambient temperature.

According to the above-described process a wire mesh screen having a service life up to several times greater than a comparable screen produced from medium to high carbon content steel was produced.

While the invention has been described in connection with certain preferred embodiments, it is not intended to limit the scope of the invention to the particular forms set forth, but, on the contrary, it is intended to cover such alternatives, modifications, and equivalents as may be included within the spirit and scope of the invention as defined by the appended claims.

What is claimed is:

1. A method of sorting granular product, comprising:
providing a screen having a first planar array of stainless steel wires in a longitudinal configuration, the wires having a tensile strength of at least 200,000 psi and a second planar array of stainless steel wires in a transverse configuration extending transversely of the first planar array, the wires having a tensile strength of at least 200,000, the screen having openings formed between the first and second planar arrays, the openings being sized so as to be capable of sorting granular product; and,
passing granular product through the screen such that granular product is sorted.

2. The method of claim 1, wherein the wires have a diameter between 1/16 and ⅝ inches.

3. The method of claim 1, wherein the screen is formed by arranging the first and second planar array in an electric resistance welding machine to form a plurality of junctions where longitudinal and transverse wires cross.

4. The method of claim 3, further comprising:
applying a pulse of electricity to the junction at a predetermined time, pressure, and current sufficient to cause fusion or welding of the junctions.

5. The method of claim 4, where the pulse of electricity is applied at about 5,000 amps and 2,750 psi for 40 cycles.
